(19) United States
(12) Patent Application Publication
(10) Pub. No.: US 2012/0194153 A1
(43) Pub. Date: Aug. 2, 2012

(54) CONSTANT VGS MOS SWITCH WITH CHARGE PUMP

(76) Inventor: Carmine Cozzolino, Encinitas, CA (US)

(21) Appl. No.: 13/019,106

(22) Filed: Feb. 1, 2011

(51) Int. Cl. G05F 1/10

(52) U.S. Cl. 323/282

(57) ABSTRACT

A system comprises a switch circuit including an input and a control connection and a voltage converter circuit electrically coupled to the switch circuit. The voltage converter circuit includes an input electrically coupled to the input of the switch circuit and an output electrically coupled to the control connection of the switch circuit. The output signal generated at the output includes the input signal shifted by a substantially constant voltage amplitude as the voltage of the input signal varies.

### BACKGROUND

Electronic circuits and systems often include electronic switches. An electronic switch can be used to transmit an analog signal to a circuit path or to prevent an analog signal from being sent to a circuit path. Such a switch is sometimes referred to as an analog switch or a pass switch to differentiate this type of switch from a digital switch which changes its output state in response to an input, but does not pass a received signal. An analog switch that is able to function properly for different types of analog signals can be useful in many electronic systems.

### OVERVIEW

This document relates generally to electronic switches and methods of their implementation. A system example includes a switch circuit including an input and a control connection and a voltage converter circuit electrically coupled to the switch circuit. The voltage converter circuit includes an input electrically coupled to the input of the switch circuit and an output electrically coupled to the control connection of the switch circuit. The output signal generated at the output includes the input signal shifted by a substantially constant voltage amplitude as the voltage of the input signal varies.

This section is intended to provide an overview of subject matter of the present patent application. It is not intended to provide an exclusive or exhaustive explanation of the invention. The detailed description is included to provide further information about the present patent application.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a flow diagram of an example of a method of implementing a switch circuit.

FIG. 2 shows an example of operation of a switch circuit.

FIG. 3 is a block diagram of portions of an example of a system that includes a switch circuit.

FIG. 4 shows an example of gate voltage adjustment for implementing a switch circuit.

FIGS. 5 and 6 show another example of operation of a switch circuit.

FIG. 7 is a schematic diagram of an example of a charge pump circuit.

### DETAILED DESCRIPTION

This document relates generally to electronic switches. It may be desired to pass signals through a switch circuit that have greater amplitude than the voltage provided through the control connection. Passing such a signal through a switch circuit normally would result in the switch being turned off. For example, if the switch circuit includes a MOSFET, an input signal having too great an amplitude may result in the gate to source voltage (V_{GS}) reaching the breakdown point. This may result in the output signal being clipped at, or slightly below, a supply voltage.

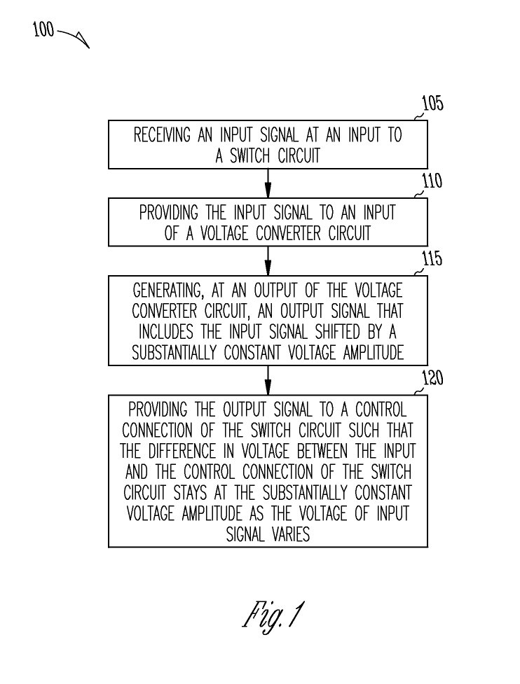

FIG. 1 is a flow diagram of an example of a method 100 of implementing a switch circuit to ensure that the control connection of the switch circuit operates properly as the signal input to the switch circuit varies. At block 105, an input signal is received at an input to a switch circuit. At block 110, the input signal is also provided to an input of a voltage converter circuit.

At block 115, an output signal that includes the input signal shifted by a substantially constant voltage amplitude is generated at an output of the voltage converter circuit. At block 120, the output signal is provided to a control connection of the switch circuit. The difference in voltage between the input and the control connection of the switch circuit stays at the substantially constant voltage amplitude as the voltage of input signal varies. The control connection voltage is thus always higher than the signal input by the constant voltage amplitude.

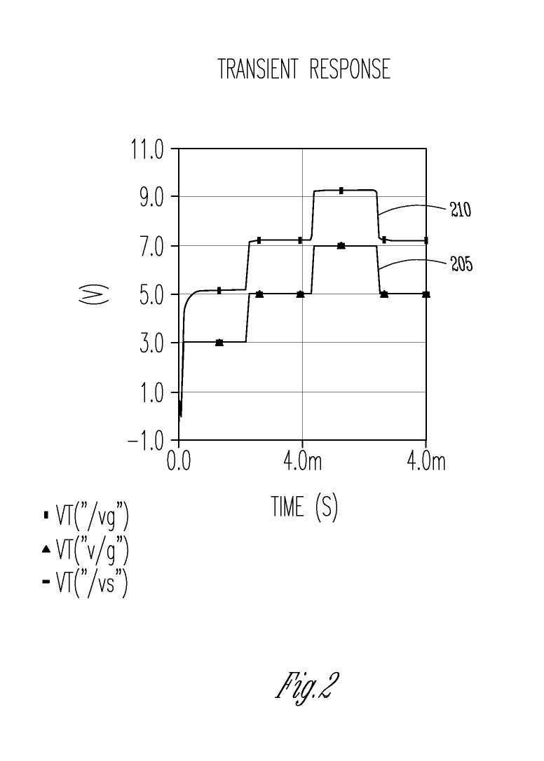

FIG. 2 shows an example of the switch circuit operating. The input signal 205 is shown stepping up from 3.0 Volts (V) to 7.0V. The signal at the control connection 210 changes with the input signal 205, but stays about 2.0V higher. Hence, the difference in voltage between the input and the control connection of the switch circuit remains at about 2.0 volts as the voltage of input signal varies. Note that 2.0 volts in just an example in the Figures, and other values of voltage differences are possible.

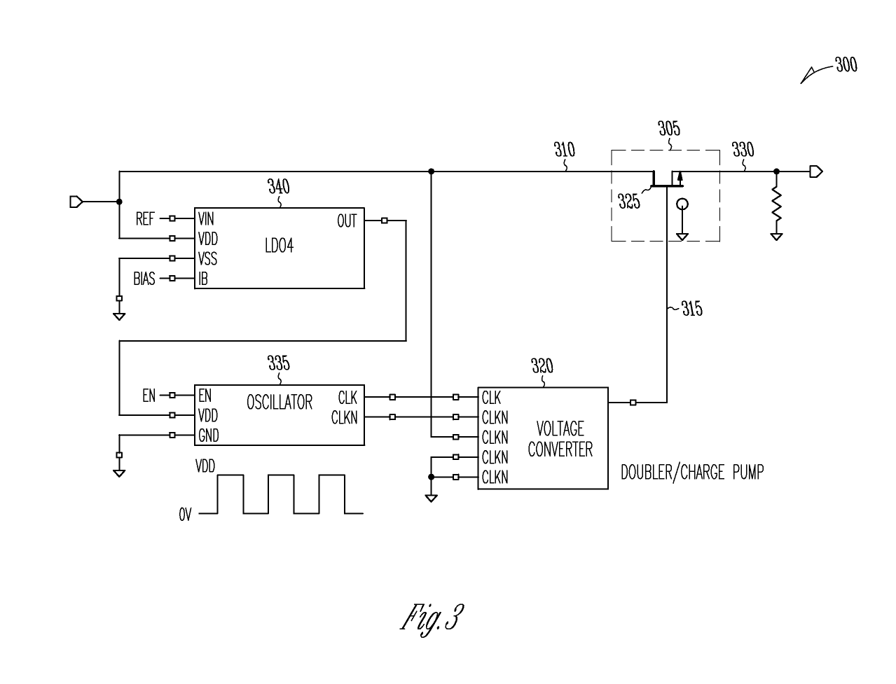

FIG. 3 is a block diagram of portions of an example of a system 300 that includes a switch circuit 305. The switch circuit 305 includes an input 310 and a control connection 315. The system 300 also includes a voltage converter circuit 320. The voltage converter circuit 320 includes an input (vin) electrically coupled to the input of the switch circuit and an output (out) electrically coupled to the control connection of the switch circuit 305. An output signal generated at the output includes the input signal shifted by a substantially constant voltage amplitude as the voltage of the input signal varies.

In some examples, the switch circuit 305 includes a pass gate 325 electrically coupled between the switch circuit input 310 and a switch circuit output 330. The pass gate 325 includes a pass transistor (e.g., a MOSFET) having a first source/drain connection and a gate connection. The gate connection is electrically coupled to the switch circuit control connection 315, such that the pass gate passes a signal received at the switch circuit input 310 to the switch circuit output 330 when the output signal of the voltage converter circuit 320 is received at the gate connection. The voltage between the first source drain connection and the gate connection (e.g., V_{GS}) is constantly adjusted to be greater than an input signal voltage by a specified voltage amplitude that is substantially constant. Thus, voltage between the first source drain connection and the gate connection is constantly adjusted away from the breakdown point.

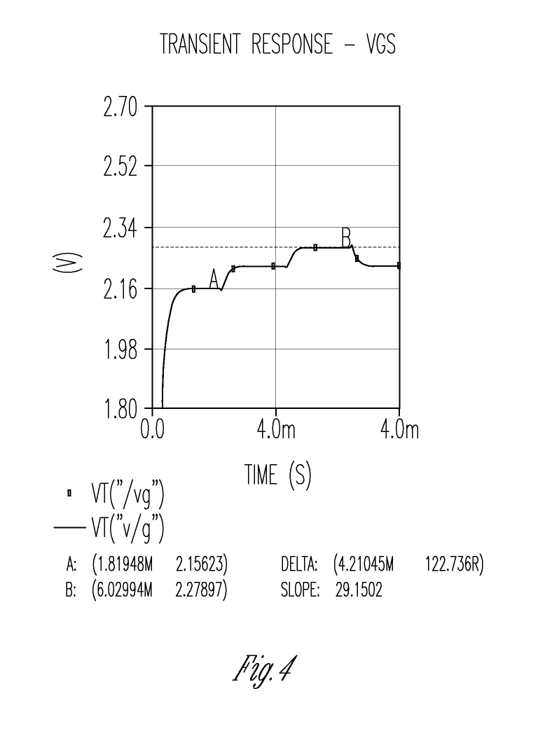

FIG. 4 shows an example of the voltage adjustment for the switch circuit operation shown in FIG. 2. As the input signal 205 changes, the gate to source voltage is adjusted to stay substantially at a constant voltage of about 2.0 volts above the input signal voltage. FIG. 4 shows the example for an NMOS switch. For a PMOS case, the gate to source voltage is adjusted to stay substantially at a constant voltage below the input signal voltage.

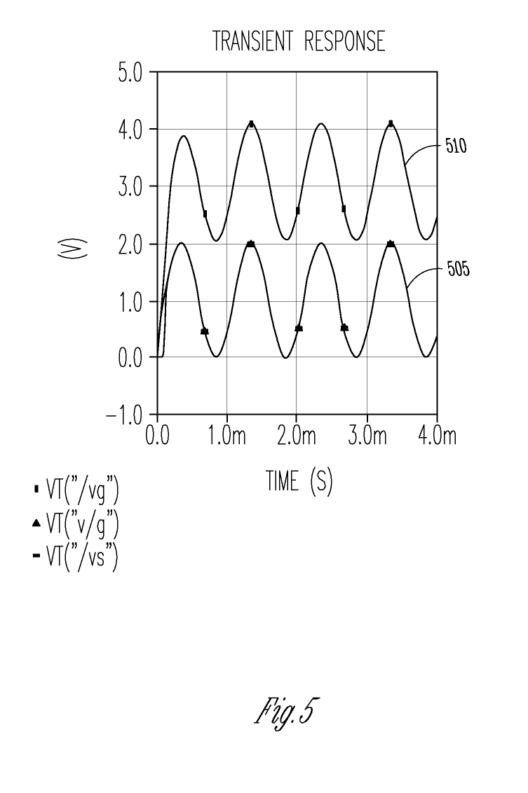

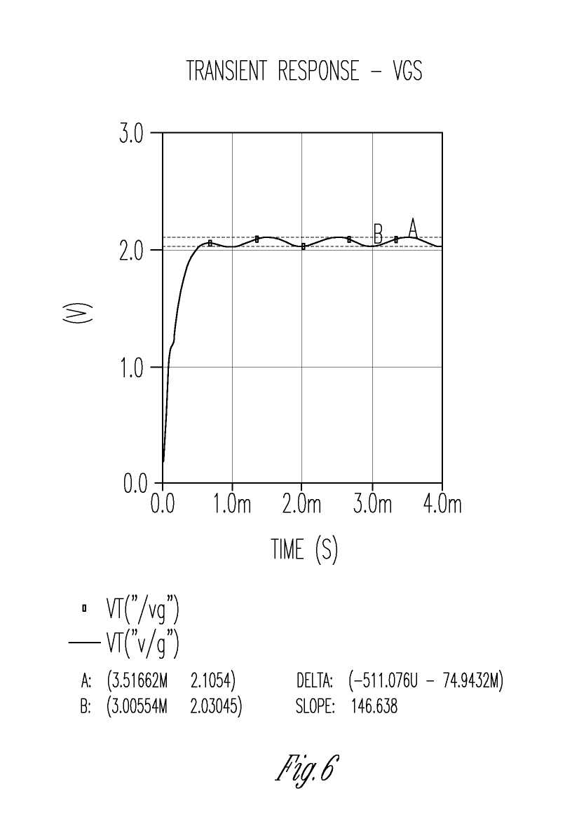

FIG. 5 shows another example of the voltage adjustment for the switch circuit operation. In this example, the input signal 505 is sinusoidal. The control connection signal 510 changes with the input signal 505, but stays about 2.0V higher. FIG. 6 shows that, as the input signal 505 changes, the voltage at the gate connection is adjusted to stay substantially constant and greater than the input signal voltage by about 2.0V.

In some examples, the pass gate 325 includes a second transistor, wherein the pass transistor and the second transistor form a complementary metal oxide semiconductor (CMOS) transistor pair. A CMOS transistor pair can increase the dynamic range of the switch circuit 305.

In some examples, the voltage converter circuit 320 includes a clock input (clk) and an output electrically coupled to the control connection of the switch circuit. A first clock signal received at the clock input includes the voltage amplitude. An output signal generated at the output includes the input signal shifted by the voltage amplitude of the first clock signal. The voltage between the first source drain connection and the gate connection is maintained at a substantially constant voltage amplitude of the first clock signal when the output signal is received at the gate connection.

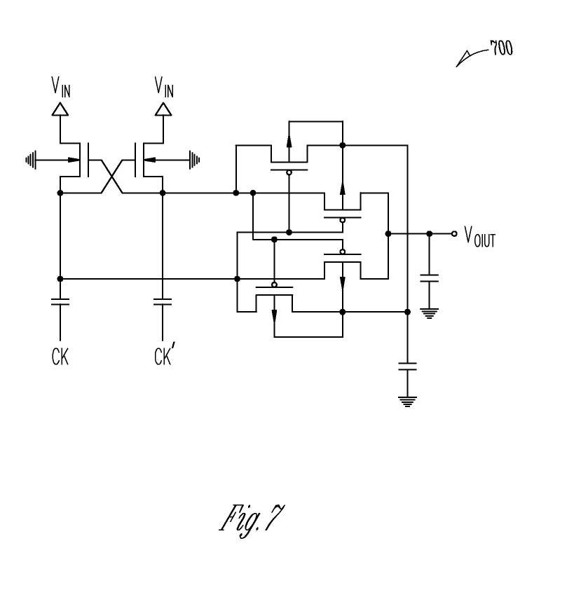

In some examples, the voltage converter circuit 320 includes a charge pump circuit. FIG. 7 is a schematic diagram of an example of a charge pump circuit 700. Operation of the clock signals results in the voltage at the output being Vᵢₙ plus the voltage level of the clock signal. If the voltage level of clock signal equals Vᵢₙ, then the charge pump functions like a voltage doubler circuit. An example of a charge pump circuit and a voltage doubler circuit can be found in Deval et al., “A High-EfficiencyCMOS Voltage Doubler,” IEEE Journal of Solid State Circuits, Vol. 33, No. 3, March 1998.

In some examples, the system 300 of FIG. 3 includes an oscillator circuit 335 electrically coupled to the charge pump circuit 320 to provide at least the first clock signal. In certain examples, the system 300 includes a low drop out (LDO) regulator circuit 340 electrically coupled to the oscillator circuit. The LDO circuit generates a regulated voltage that is substantially equal to the voltage amplitude of the first clock signal. In certain examples, the LDO circuit generates a regulated voltage of 2.0V from a 5V source. In certain examples, the LDO circuit 340 is powered from a different supply voltage (e.g., different from V_{dd}) from the rest of the system 300. If the system includes a charge pump circuit, the LDO circuit 340 may not be needed if the amplitudes of the clock signals of the charge pump circuit are sufficiently high.

In some examples, the system 300 includes an integrated circuit, and the switch circuit and the voltage converter circuit are included in the integrated circuit. The integrated circuit can be used in any electronic system where there is a need for a switch circuit that guarantees that a control connection (e.g., a transistor gate) stays above the voltage at the circuit input (e.g., a transistor source).

In certain examples, the integrated circuit is included in a battery-protection system. The integrated circuit is used to generate logic signals needed to control circuits that provide functions such as removing a battery from a circuit. In certain examples, the integrated circuit is included in an electronic battery-protection system of a cellular phone (e.g., the input can be a voltage from a wall charger). In certain examples, the integrated circuit is included in an electronic battery-charging system, such as a battery-charging system connectable to a universal serial bus (USB) port.

### Additional Notes

Example 1 includes subject (such as a system) comprising a switch circuit including an input and a control connection and a voltage converter circuit electrically coupled to the switch circuit. The voltage converter includes an input electrically coupled to the input of the switch circuit and an output electrically coupled to the control connection of the switch circuit, wherein an output signal generated at the output includes the input signal shifted by a substantially constant voltage amplitude as the voltage of the input signal varies.

In Example 2, the voltage converter circuit of Example 1 can optionally include a clock input and an output electrically coupled to the control connection of the switch circuit. A first clock signal received at the clock input can include the voltage amplitude, and an output signal generated at the output includes the input signal shifted by the voltage amplitude of the first clock signal.

In Example 3, the switch circuit of one or any combination of Examples 1 and 2 can optionally include a pass gate electrically coupled between the switch circuit input and a switch circuit output. The pass gate can optionally include a pass transistor having a first source/drain connection and a gate connection. The gate connection is electrically coupled to the switch circuit control connection, such that the pass gate is configured to pass a signal received at the switch circuit input to the switch circuit output when the output signal of the voltage converter circuit is received at the gate connection and a voltage between the first source drain connection and the gate connection is maintained at a substantially constant voltage amplitude of the first clock signal when the output signal is received.

In Example 4, the switch circuit of one or any combination of Examples 1-2 can optionally include a pass gate electrically coupled between the switch circuit input and a switch circuit output. The pass gate can optionally include a pass transistor having a first source/drain connection and a gate connection, wherein the gate connection is electrically coupled to the switch circuit control connection, such that the pass gate is configured to pass a signal received at the switch circuit input to the switch circuit output when the output signal of the voltage converter circuit is received at the gate connection, and a voltage between the first source drain connection and the gate connection is constantly adjusted to be greater than an input signal voltage by the substantially constant voltage amplitude.

In Example 5, the pass gate of one or any combination of Examples 3-4 can optionally include a second transistor, and the pass transistor and the second transistor form a complementary metal oxide semiconductor transistor pair.

In Example 6, the voltage converter circuit of one or any combination of Examples 1-5 can optionally include a charge pump circuit.

In Example 7, the charge pump circuit of Example 6 can optionally include a second clock input. A second clock signal received at the second clock input is optionally out of phase with the first clock signal.

In Example 8, the subject matter of one or any combination of Examples 6 and 7 can optionally include an oscillator circuit electrically coupled to the charge pump circuit to provide the first clock signal, and a low drop out (LDO) regulator circuit electrically coupled to the oscillator circuit and configured to generate a regulated voltage substantially equal to the voltage amplitude of the first clock signal.

In Example 9, the voltage converter circuit of one or any combination of Examples 108 can optionally include a voltage-doubler circuit.

In Example 10, the switch circuit and the voltage converter circuit of one or any combination of Examples 1-9 can optionally be included in an integrated circuit.

In Example 11, the integrated circuit of Example 10 is optionally included in a battery-charging system.

In Example 12, the integrated circuit of one or any combination of Examples 10 and 11 can optionally be included in an electronic battery-charging system of a cellular phone.

In Example 13, the integrated circuit of one or any combination of Examples 10-12 can optionally be included in an electronic battery-charging system connectable to a universal serial bus (USB) port.

Example 14 can include subject matter, or can optionally be combined with the subject matter of one or any combination of Examples 1-13 to include subject matter, (such as a method, a means for performing acts, or a machine-readable medium including instructions that, when performed by the machine, cause the machine to perform acts) comprising receiving an input signal at an input to a switch circuit, providing the input signal to an input of a voltage converter circuit, generating, at an output of the voltage converter circuit, an output signal that includes the input signal shifted by a substantially constant voltage amplitude, and providing the output signal to a control connection of the switch circuit such that a difference in voltage between the input and the control connection of the switch circuit stays at the substantially constant voltage amplitude as the voltage of input signal varies.

In Example 15, the subject matter of Example 14 can optionally include receiving a clock signal at a clock input of the voltage converter circuit, wherein a voltage amplitude value of the clock signal includes the voltage amplitude of the substantially constant voltage amplitude.

In Example 16, the receiving an input signal at an input to a switch circuit of one or any combination of Examples 14 and 15 can optionally include receiving an input signal at a first source/drain connection of a transistor and passing the input signal to a second source/drain connection upon activation of a transistor gate connection, and the providing the output signal to a control connection of the switch circuit can optionally include providing the output signal to the transistor gate connection, such that a voltage difference between the gate connection and the first source/drain connection is substantially the voltage amplitude of the clock signal.

In Example 17, the receiving an input signal at an input to a switch circuit of one or any combination of Examples 14-16 can optionally include receiving an input signal at a first source/drain connection of a transistor and passing the input signal to a second source/drain connection upon activation of a transistor gate connection, and the providing the output signal to a control connection of the switch circuit can optionally include providing an output signal to the transistor gate connection that maintains a substantially constant resistance between the first source/drain connection and the second source/drain connection as the input signal varies.

In Example 18, the receiving an input signal of one or any combination of Examples 14-17 can optionally include receiving an input signal to charge a battery.

In Example 19, the input signal to charge the battery of one or any combination of Examples 14-18 optionally has an amplitude substantially equal to the voltage amplitude of the clock signal.

In Example 20, the receiving an input signal of one or any combination of Examples 14-19 can optionally include receiving an input signal from a USB connection.

Example 21 can include, or can optionally be combined with any portion or combination of any portions of any one or more of Examples 1-20 to include, subject matter that can include means for performing any one or more of the functions of Examples 1-20, or a machine-readable medium including instructions that, when performed by a machine, cause the machine to perform any one or more of the functions of Examples 1-20.

These non-limiting examples can be combined in any permutation or combination.

The above detailed description includes references to the accompanying drawings, which form a part of the detailed description. The drawings show, by way of illustration, specific embodiments in which the invention can be practiced. These embodiments are also referred to herein as “examples.” All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects. Method examples described herein can be machine or computer-implemented at least in part.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. §1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the invention should be determined with reference to the appended claims, along with the full scope of equivalents to which such claims are entitled.

What is claimed is:

1. A system comprising:
a switch circuit including an input and a control connection;
a voltage converter circuit electrically coupled to the switch circuit, the voltage converter including:
an input electrically coupled to the input of the switch circuit;
an output electrically coupled to the control connection of the switch circuit, wherein an output signal generated at the output includes the input signal shifted by a substantially constant voltage amplitude as the voltage of the input signal varies.

2. The system of claim 1, wherein the voltage converter circuit includes a clock input, wherein a first clock signal received at the clock input includes the voltage amplitude; and
an output electrically coupled to the control connection of the switch circuit, wherein an output signal generated at the output includes the input signal shifted by the voltage amplitude of the first clock signal.

3. The system of claim 2, wherein the switch circuit includes:
a pass gate electrically coupled between the switch circuit input and a switch circuit output, wherein the pass gate includes:
a pass transistor having a first source/drain connection and a gate connection, wherein the gate connection is electrically coupled to the switch circuit control connection, such that the pass gate is configured to pass a signal received at the switch circuit input to the switch circuit output when the output signal of the voltage converter circuit is received at the gate connection, and
wherein a voltage between the first source drain connection and the gate connection is maintained at a substantially constant voltage amplitude of the first clock signal when the output signal is received.

4. The system of claim 1, wherein the switch circuit includes:
a pass gate electrically coupled between the switch circuit input and a switch circuit output, wherein the pass gate includes:
a pass transistor having a first source/drain connection and a gate connection, wherein the gate connection is electrically coupled to the switch circuit control connection, such that the pass gate is configured to pass a signal received at the switch circuit input to the switch circuit output when the output signal of the voltage converter circuit is received at the gate connection, and
wherein a voltage between the first source drain connection and the gate connection is constantly adjusted to be greater than an input signal voltage by the substantially constant voltage amplitude.

5. The system of claim 4, wherein the pass gate includes a second transistor, wherein the pass transistor and the second transistor form a complementary metal oxide semiconductor transistor pair.

6. The system of claim 1, wherein the voltage converter circuit includes a charge pump circuit.

7. The system of claims 6, wherein the charge pump circuit includes a second clock input, wherein a second clock signal received at the second clock input is out of phase with the first clock signal.

8. The system of claim 6, including:
an oscillator circuit electrically coupled to the charge pump circuit to provide the first clock signal; and
a low drop out (LDO) regulator circuit electrically coupled to the oscillator circuit and configured to generate a regulated voltage substantially equal to the voltage amplitude of the first clock signal.

9. The system of claim 1, wherein the voltage converter circuit includes a voltage-doubler circuit.

10. The system of claim 1, including an integrated circuit, wherein the switch circuit and the voltage converter circuit are included in the integrated circuit.

11. The integrated circuit of claim 8, wherein the integrated circuit is included in a battery-charging system.

12. The integrated circuit of claim 11, wherein the integrated circuit is included in an electronic battery-charging system of a cellular phone.

13. The integrated circuit of claim 11, wherein the integrated circuit is included in an electronic battery-charging system connectable to a universal serial bus (USB) port.

14. A method comprising:
receiving an input signal at an input to a switch circuit;
providing the input signal to an input of a voltage converter circuit;
generating, at an output of the voltage converter circuit, an output signal that includes the input signal shifted by a substantially constant voltage amplitude; and
providing the output signal to a control connection of the switch circuit such that a difference in voltage between the input and the control connection of the switch circuit stays at the substantially constant voltage amplitude as the voltage of input signal varies.

15. The method of claim 12 including receiving a clock signal at a clock input of the voltage converter circuit, wherein a voltage amplitude value of the clock signal includes the voltage amplitude of the substantially constant voltage amplitude.

16. The method of claim 15,
wherein receiving an input signal at an input to a switch circuit includes receiving an input signal at a first source/drain connection of a transistor and passing the input signal to a second source/drain connection upon activation of a transistor gate connection, and
wherein providing the output signal to a control connection of the switch circuit includes providing the output signal to the transistor gate connection, such that a voltage difference between the gate connection and the first source/drain connection is substantially the voltage amplitude of the clock signal.

17. The method of claim 14,
wherein receiving an input signal at an input to a switch circuit includes receiving an input signal at a first source/drain connection of a transistor and passing the input signal to a second source/drain connection upon activation of a transistor gate connection, and
wherein providing the output signal to a control connection of the switch circuit includes providing an output signal to the transistor gate connection that maintains a substantially constant resistance between the first source/drain connection and the second source/drain connection as the input signal varies.

18. The method of claim 14, wherein receiving an input signal includes receiving an input signal to charge a battery.

19. The method of claim 14, wherein the input signal to charge the battery has an amplitude substantially equal to the voltage amplitude of the clock signal.

20. The method of claim 14, wherein receiving an input signal includes receiving an input signal from a USB connection.
